(19) United States
(12) Patent Application Publication
(10) Pub. No.: US 2025/0250831 A1
(43) Pub. Date: Aug. 7, 2025

(54) WINDOW OPENING CONTROL DEVICE

(71) Applicant: Visionar Window Systems Inc., Abbotsford (CA)

(72) Inventors: Johan Sawatzky, Langley (CA); Brent Friesen, Langley (CA)

(21) Appl. No.: 19/045,432

(22) Filed: Feb. 4, 2025

Related U.S. Application Data
(60) Provisional application No. 63/549,761, filed on Feb. 5, 2024.

(51) Int. Cl. E05C 17/34

(52) U.S. Cl. CPC E05C 17/34

(57) ABSTRACT

A window opening control device for facilitating the secure and adjustable opening of a window. The device features a frame portion having a frame-mount portion for attachment to a window frame and a pivotably attached frame arm, which includes either a pin or a slot. The corresponding sash portion contains a sash-mount portion for attachment to a window sash and a pivotably attached sash arm, which includes the other of the pin or the slot. These components allow for movement between an unlocked position, where the pin is disengaged from the slot, and a locked position, where the pin is secured within the slot. The configuration helps to prevent the window from opening beyond a predetermined distance when the frame and sash arms are locked together, and requires the arms to be unlocked prior to further opening the window.

### CROSS-REFERENCE TO RELATED APPLICATIONS

The present application claims priority to U.S. provisional patent application No. 63/549,761, filed on Feb. 5, 2024, and entitled, “Window Opening Control Device,” the entirety of which is hereby incorporated by reference herein.

### TECHNICAL FIELD

The present disclosure is directed to a device designed to control the opening of a window, a manner of using the device, and to the related window assembly.

### BACKGROUND

Windows are essential components of buildings, providing ventilation, natural light and aesthetic appeal. However, the need to balance ease-of-use (e.g., window opening and closing) and safety has always been an important aspect of window design. Traditional window designs can pose safety risks, especially in high-rise buildings or homes with young children, where uncontrolled window openings can lead to accidents.

### SUMMARY

According to a first aspect, there is provided a window opening control device, comprising a frame portion and a sash portion. The frame portion comprises: a frame-mount portion for coupling to a window frame; and a frame arm pivotably coupled to the frame-mount portion, wherein the frame arm comprises one of a pin or a slot, wherein the pin is shaped to fit within the slot. The sash portion comprises: a sash-mount portion for coupling to a window sash; and a sash arm pivotably coupled to the sash-mount portion, wherein the sash arm comprises the other of the pin or the slot. The frame and sash arms are movable between an unlocked position in which the pin is outside the slot, and a locked position in which the pin is secured in the slot. The arm that comprises the slot further comprises a notch for permitting the pin to slide therethrough and into the slot. The pin is slidable to a locked end of the slot when the frame and sash arms are in the locked position.

In one embodiment, the arm comprising the slot may comprise two fingers separated by the notch, and at least one of the fingers may be flexible or pivotable relative to the arm to permit enlargement of the notch such that the pin is able to pass through the notch. Additionally, the two fingers may be connected at opposing ends of the slot and extend such that ends of the two fingers are misaligned relative to each other.

In one embodiment, the window opening control device may further comprise a sleeve slidably mounted on the arm that comprises the slot, and the sleeve may be adjustable between a protected position, in which the sleeve covers the notch, and an unprotected position, in which the notch is exposed.

In one embodiment, the notch may be sized to prevent the pin from exiting the slot through the notch when the pin is in the slot and the at least one of the fingers is unflexed or unpivoted.

In one embodiment, the pin and the slot may be positioned such that the frame and sash arms automatically return to the locked position when the window frame is closed against the window sash.

In one embodiment, the arm that comprises the slot may further comprise a slot edge adjacent the notch to guide the pin towards the notch as the window sash is closed from the unlocked position against the window frame.

In one embodiment, an end of the frame arm may be pivotably coupled to the frame-mount portion, one half of the end of the frame arm may comprise a curved edge to allow the frame arm to pivot about the frame-mount portion with the curved edge rotating adjacent a frame baffle of the frame-mount portion, and an opposing half of the end of the frame arm may be shaped to abut against the frame baffle of the frame-mount portion to limit pivoting of the frame arm.

In one embodiment, an end of the sash arm may be pivotably coupled to the sash-mount portion, one half of the end of the sash arm may comprise a curved edge to allow the sash arm to pivot about the sash-mount portion along the curved edge rotating adjacent a sash baffle of the sash-mount portion, and an opposing half of the end of the sash arm may be shaped to abut against the sash baffle of the sash-mount portion to limit pivoting of the sash arm.

In one embodiment, the device may further comprise at least one spring connecting at least one of the arms to at least one of the frame-mount and sash-mount portions, respectively, and the at least one spring may bias an end of the at least one of the arms away from the at least one of the frame-mount and sash-mount portions, respectively.

In one embodiment, the at least one spring may bias the arm that comprises the slot.

In one embodiment, the frame arm may further comprise a frame ridge positioned to abut against a frame baffle of the frame-mount portion when the frame arm is pivoted to be parallel with the frame-mount portion.

In one embodiment, the sash arm may further comprise a sash ridge positioned to abut against a sash baffle of the sash-mount portion when the sash arm is pivoted to be parallel with the sash-mount portion.

In one embodiment, the frame arm may be pivotably coupled to the frame-mount portion between ends of the frame arm, and the frame-mount portion may comprise a frame slot through which a segment of the frame arm is extendable.

In one embodiment, the frame-mount portion may be rigidly couplable to the window frame, and the sash-mount portion may be rigidly couplable to the window sash.

In one embodiment, the frame-mount and sash-mount portions may be pivotably coupled to each other and pivotably couplable to the window frame and the window sash at attachment points on the frame-mount and sash-mount portions, respectively, and the attachment points on the frame-mount and sash-mount portions may be closer to each other when the frame and sash arms are in the locked position than when the frame and sash arms are in the unlocked position.

In one embodiment, the device may further comprise a frame bracket that is rigidly couplable to the window frame at the attachment point of the frame-mount portion, and a sash bracket that is rigidly couplable to the window sash at the attachment point of the sash-mount portion.

In one embodiment, when in the locked position a window to which the window opening control device is attached may be prevented from opening beyond approximate 4 inches.

In one embodiment, when in the locked position the sash arm, frame arm, sash-mount portion, and frame-mount portion may be pivotable to overlap with each other.

In one embodiment, the locked position may limit a maximum gap between the window sash and the window frame, and the pin may be slidable between the locked end and the first end of the slot when the window frame is spaced from the window sash by less than the maximum gap.

According to a second aspect, there is provided a window assembly comprising a window frame; a window sash; and a window opening control device. The device comprises a frame portion and a sash portion. The frame portion comprises a frame-mount portion coupled to the window frame; and a frame arm pivotably coupled to the frame-mount portion, wherein the frame arm comprises one of a pin or a slot, wherein the pin is shaped to fit within the slot. The sash portion comprises: a sash-mount portion coupled to the window sash; and a sash arm pivotably coupled to the sash-mount portion, wherein the sash arm comprises the other of the pin or the slot. The frame and sash arms are movable between an unlocked position in which the pin is outside the slot, and a locked position in which the pin is secured in the slot. The arm that comprises the slot further comprises a notch for permitting the pin to slide therethrough and into the slot. The pin is slidable to a locked end of the slot when the frame and sash arms are in the locked position.

In one embodiment, the arm comprising the slot may comprise two fingers separated by the notch, and at least one of the fingers may be flexible or pivotable relative to the arm to permit enlargement of the notch such that the pin is able to pass through the notch. Additionally, the two fingers may be connected at opposing ends of the slot and extend such that ends of the two fingers are misaligned relative to each other.

In one embodiment, the window opening control device may further comprise a sleeve slidably mounted on the arm that comprises the slot, and the sleeve may be adjustable between a protected position, in which the sleeve covers the notch, and an unprotected position, in which the notch is exposed.

In one embodiment, the notch may be sized to prevent the pin from exiting the slot through the notch when the pin is in the slot and the at least one of the fingers is unflexed or unpivoted.

In one embodiment, the pin and the slot may be positioned such that the frame and sash arms automatically return to the locked position when the window frame is closed against the window sash.

In one embodiment, the arm that comprises the slot may further comprise a slot edge adjacent the notch to guide the pin towards the notch as the window sash is closed from the unlocked position against the window frame.

According to a third aspect, there is provided a method for operating a window opening control device, the window opening control device comprising a frame portion and a sash portion, the frame portion comprising a frame-mount portion for coupling to a window frame and a frame arm pivotably coupled to the frame-mount portion, the sash portion comprising a sash-mount portion for coupling to a window sash and a sash arm pivotably coupled to the sash-mount portion, wherein the method comprises: opening the sash-mount portion away from the frame-mount portion when a pin on one of the frame arm or sash arm is secured in a slot on the other of the frame arm or sash arm, until the window opening control device opens to a maximum locked distance and further opening is prevented by virtue of the pin abutting against a locked end of the slot; closing the sash-mount portion towards the frame-mount portion with one hand so that the window sash is spaced from the window frame by less than the maximum locked distance; removing the pin from the slot with the other hand; and then further opening the sash-mount portion away from the frame-mount portion.

In one embodiment, the method may further comprise, prior to removing the pin from the slot: adjusting a sleeve that is slidably mounted on the arm that comprises the slot from a protected position, in which the sleeve covers the notch, to an unprotected position, in which the notch is exposed.

In one embodiment, the arm comprising the slot may comprise two fingers separated by the notch, and removing the pin from the slot may comprise: flexing at least one of the fingers to enlarge the notch such that the pin is able to pass through the notch.

In one embodiment, the method may further comprise, after the pin is removed from the slot: moving the sash-mount portion and the frame-mount portion toward each other until the pin contacts the arm that comprises the notch and slides towards the notch; and further moving the sash-mount portion and the frame-mount portion toward each other until the pin slides through the notch into the slot.

This summary does not necessarily describe the full scope of all aspects. Other aspects, features and advantages will become apparent to those of ordinary skill in the art upon review of the following description of specific embodiments.

### BRIEF DESCRIPTION OF THE DRAWINGS

In the accompanying drawings, which illustrate one or more example embodiments:

FIG. 1 is a perspective view of a window opening control device, according to a first embodiment.

FIG. 2 is a perspective view of the window opening control device from another angle, according to the first embodiment.

FIG. 3 is a side view of the window opening control device, according to the first embodiment.

FIG. 4 is an exploded view of the window opening control device, according to the first embodiment.

FIG. 5 is a perspective view of the window opening control device, according to a second embodiment.

FIG. 6 is a perspective view of the window opening control device from another angle, according to the second embodiment.

FIG. 7 is a side view of the window opening control device, according to the second embodiment.

FIG. 8 is an exploded view of the window opening control device, according to the second embodiment.

FIG. 9 is a perspective view of the window opening control device, according to a third embodiment.

FIG. 10 is a perspective view of the window opening control device from another angle, according to the third embodiment.

FIG. 11 is an exploded view of the window opening control device, according to the third embodiment.

FIG. 12 is a perspective view of the window opening control device, according to a fourth embodiment.

FIG. 13 is a perspective view of the window opening control device when the sash arm is detached from the frame arm, according to the fourth embodiment.

FIG. 14 is a perspective view of the frame arm of the window opening control device, according to the fourth embodiment.

FIG. 15 is a perspective view of a window assembly incorporating the embodiment of the window opening control device shown in FIG. 1.

FIGS. 16 and 17 are perspective views of a window assembly incorporating the embodiment of the window opening control device shown in FIG. 9 at respective locked and unlocked positions.

FIGS. 18-22 illustrate various positions of the embodiment of the window opening control device of FIG. 9 as it transitions from the locked position to the unlocked position.

FIGS. 23-25 illustrate various positions of the embodiment of the window opening control device of FIG. 9 as it transitions from the unlocked position to the locked position.

FIGS. 26-28 illustrate various positions of the embodiment of the window opening control device of FIG. 12 as it transitions from the locked position to the unlocked position.

### DETAILED DESCRIPTION

A Window Opening Control Device (WOCD) is a mechanism designed to regulate the opening of windows, particularly in residential buildings where children may have access to the windows. It serves as a safety feature by controlling and limiting the extent to which a window can be opened. The primary function of a WOCD is to prevent unintended, unrestricted window opening, thereby reducing the risk of accidents, especially in environments with children or in elevated structures. The device by default limits the how wide the window to which the WOCD is attached can open, yet can be overridden quickly and easily by an adult as desired to permit wider opening.

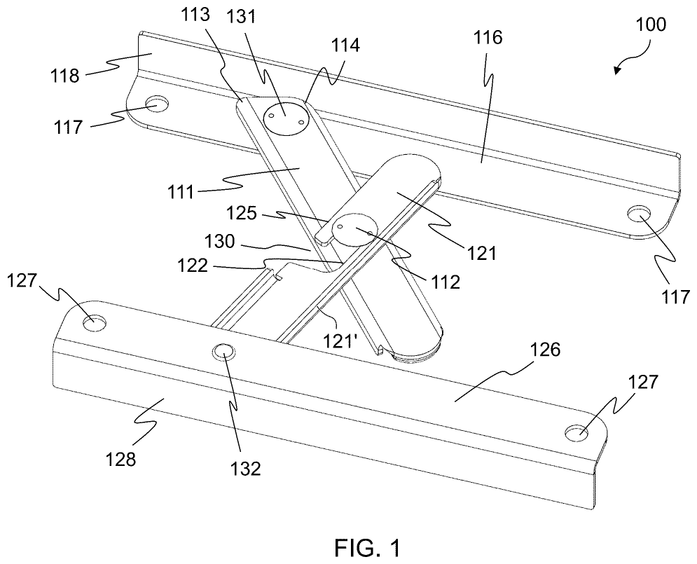

FIGS. 1-4 collectively illustrate a first embodiment of a window opening control device, designated WOCD 100. These figures are referenced in the detailed description of this embodiment to provide a comprehensive visual guide to its structure and functionality.

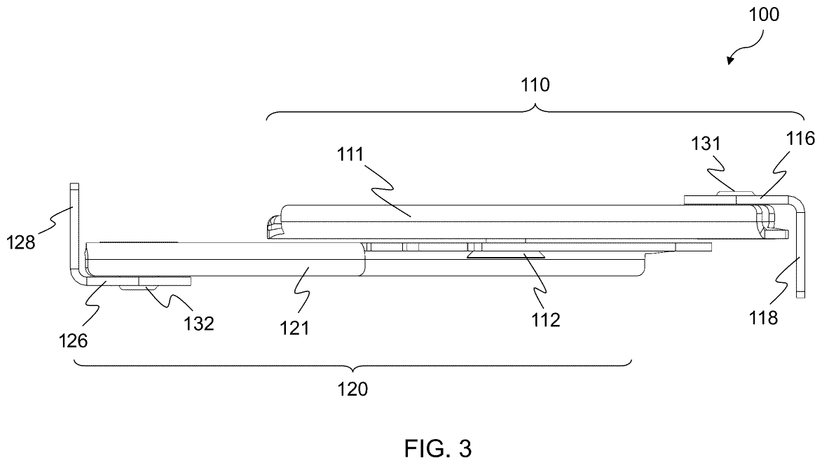

The WOCD 100 comprises a sash portion 110 and a frame portion 120, as shown in FIG. 3. The sash portion 110 is specifically configured for mounting on to a window sash, while the frame portion 120 is correspondingly configured to be mounted onto a window frame. This arrangement enables the WOCD 100 to effectively regulate the extent to which the window sash can be opened, ensuring it only opens up to a predefined distance or angle relative to the window frame when the sash portion 110 is securely engaged with the frame portion 120.

In operation, when the window sash is opened relative to the window frame, the sash portion 110 can be disengaged from the frame portion 120 by having a user, such as the parent of a child, manually release a locking mechanism that comprises part of the WOCD 100. This disengagement facilitates the further opening of the window sash relative to the window frame.

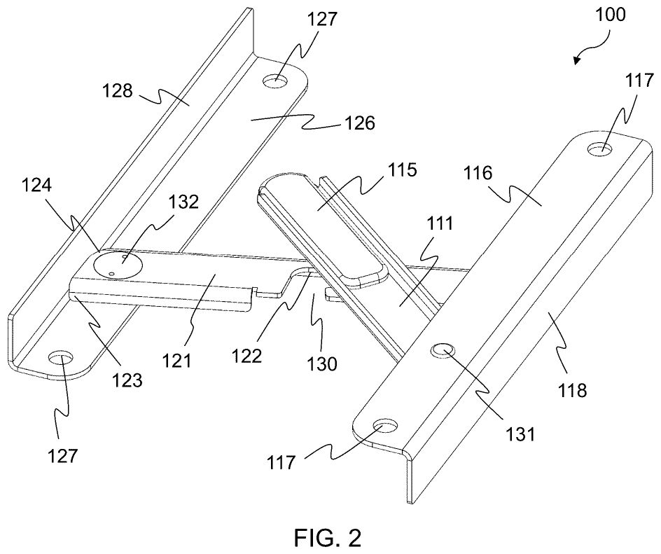

As shown in FIGS. 1 and 2, the sash portion 110 includes a sash-mount portion 116 and a sash arm 111 that is pivotably coupled to the sash-mount portion 116 using a first sash bolt 131. The first sash bolt 131 is located at one end of the sash arm 111, so that the sash arm 111 can be pivotably rotated relative to the sash-mount portion 116 at that end. Similarly, the frame portion 120 includes a frame-mount portion 126 and a frame arm 121 that is pivotably coupled to the frame-mount portion 126 using a first frame bolt 132. The first frame bolt 132 is located at one end of the frame arm 121, so that the frame arm 121 can be pivotably rotated relative to the frame-mount portion 126 at that end. Both the sash and frame arms 111, 121 are shaped as elongated plates. This design facilitates their overlap and allows a scissor-like movement when they are hinged together, the details of which will be explained later in the description.

It should be appreciated that while a bolt is used in this specific embodiment for the first sash bolt 131 or the first frame bolt 132, this should not be seen as limiting. Alternative means facilitating pivotable movement (e.g., rivets, clips) are also envisaged within the scope of this disclosure.

In this embodiment, the sash-mount portion 116 is equipped with multiple sash mounting holes 117. These holes facilitate a rigid attachment of the sash-mount portion 116 to the window sash using appropriate fasteners, such as screws. Similarly, the frame-mount portion 126 is equipped with multiple frame mounting holes 127 to enable its rigid attachment to the window frame using corresponding fasteners. It should be appreciated that both the quantity and arrangement of the mounting holes in the sash-mount portion 116 and the frame-mount portion 126 are variable and not limited to any specific configuration.

A pin 112 is located on the sash arm 111 between the two ends of the sash arm 111. This pin 112, which protrudes from a surface of the sash arm 111, is shaped to interface with a slot 122 disposed on the frame arm 121. The slot 122, which extends longitudinally along the frame arm 121, is sized to receive the pin 112. In addition, a notch 130 is provided on the edge of the frame arm 121 to serve as both an entry and exit point for the pin 112 into and out of the slot 122, respectively. This notch 130 is sized to allow the pin 112 to pass through it, entering at a first end of the slot 122. The slot 122 is sized to permit the pin 112 to slide from the slot's 122 first end to an opposite locked end, or vice versa, allowing for bi-directional movement. Once the pin 112 is at the locked end of the slot 122, it is securely coupled to the sash arm 111 and frame arm 121, meaning that the pin 112 cannot escape from the slot 122 except through the notch 130. This configuration allows pivotal movement between the two arms 111, 121 while the pin 112 is in the slot 122.

The interaction between the pin 112 and the slot 122 serves as an indicator of the WOCD 100's status. Engagement of the pin 112 within the slot 122 (i.e., the pin 112 is secured in the slot 122) indicates that the WOCD 100 is in a locked position or state. Conversely, disengagement (i.e., the pin 112 is outside the slot 122) indicates an unlocked position or state. In the locked position, the maximum gap between the window sash and the window frame is restricted to a predetermined value, such as 4 inches, as defined by the lengths of the sash and frame arms 111, 121. This predetermined value is hereinafter referred to as the “maximum locked distance”. This locked position may be altered to an unlocked position through a simple, user-friendly operation, notably achievable with a one-hand maneuver on the sash arm 111. In the unlocked position, because the pin 112 and the slot 122 are no longer engaged, the window sash can be opened further away from the window frame than the maximum locked distance, facilitating greater ventilation or access as desired.

In one embodiment, the frame arm 121 may be provided with a slot edge 125, positioned adjacent the notch 130. This slot edge 125, situated on the same edge of the frame arm 121 as the notch 130, is contoured to guide the pin 112 when transitioning the WOCD 100 from the unlocked to locked position. Such an arrangement guides the pin 112 along the edge of the frame arm 121 towards the notch 130 as the window frame moves towards the window sash.

In one embodiment, as shown in FIG. 1, the sash arm 111 may be constructed for controlled pivoting relative to the sash-mount portion 116. Specifically, at the end of the sash arm 111 where the first sash bolt 131 is located, one half of this end is contoured with a sash curved edge 114. This curvature facilitates pivoting of the sash arm 111 about the sash-mount portion 116. The pivoting movement occurs along the sash curved edge 114, enabling rotation adjacent to a sash baffle 118 integrated into the sash-mount portion 116. The sash baffle 118 may impart an “L”-shaped profile to the sash-mount portion 116 when viewed from an end of the sash-mount portion 116, as illustrated in FIG. 3. Conversely, the other half of the end where the first sash bolt 131 is located is shaped to prevent excessive pivoting. This may be achieved either by a distinct shaping of this half or by the incorporation of an additional component. For example, a sash stop 113 is provided as a part of the sash arm 111 and is shaped as a sharp edge. As the sash arm 111 pivots away from the sash-mount portion 116, this sharp edge abuts against the sash baffle 118 after the sash arm 111 has rotated beyond a maximum angle, thereby limiting range of motion.

Likewise, as shown in FIG. 2, the frame arm 121 may be constructed for controlled pivoting relative to the frame-mount portion 126. Specifically, at the end of the frame arm 121 where the first frame bolt 132 is located, one half of this end is contoured with a frame curved edge 124. This curvature facilitates pivoting of the frame arm 121 about the frame-mount portion 126. The pivoting movement occurs along the frame curved edge 124, enabling rotation adjacent to a frame baffle 128 integrated into the frame-mount portion 126. The frame baffle 128 may impart an “L”-shaped profile to the frame-mount portion 126 when viewed from an end of the frame-mount portion 126, as illustrated in FIG. 3. Conversely, the other half of the end where the first frame bolt 132 is located is shaped to prevent excessive pivoting. This may be achieved either by a distinct shaping of this half or by the incorporation of an additional component. For example, a frame stop 123 is provided as a part of the frame arm 121 and is shaped as a sharp edge. As the frame arm 121 pivots away from the frame-mount portion 126, this sharp edge abuts against the frame baffle 128 after the frame arm 121 has rotated beyond a maximum angle, thereby limiting range of motion.

In one embodiment, as shown in FIG. 2, the sash arm 111 may be provided with a sash ridge 111′ located along its edge. This sash ridge 111′ is constructed to come into contact with the sash baffle 118 when the sash arm 111 aligns parallel to the sash-mount portion 116. Such an arrangement ensures proper alignment and reception of the sash arm 111 within the sash-mount portion 116 as the sash portion 110 and the frame portion 120 converge, as occurs when closing a window. Similarly, as shown in FIG. 1, the frame arm 121 may analogously comprise a corresponding frame ridge 121′ positioned along its edge. This frame ridge 121′ abuts the frame baffle 128 when the frame arm 121 is rotated to be parallel to the sash-mount portion 116. This arrangement also ensures proper alignment and reception of the frame arm 121 within the frame-mount portion 126 as the sash portion 110 and the frame portion 120 converge.

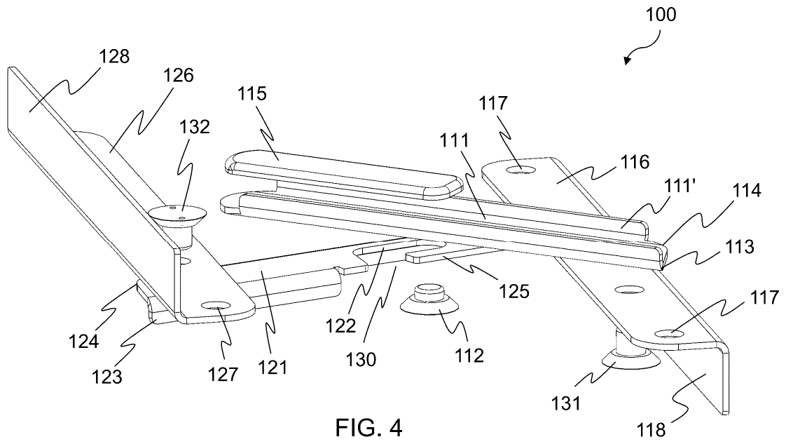

In addition, as shown in FIG. 4, the WOCD 100 may optionally include a pad 115 on the sash arm 111. The pad 115 may help a user quickly identify the arm's 111 position for adjustment.

The configuration of the elements of the WOCD 100, including the sash arm 111, the frame arm 121, the pin 112, the slot 122, the notch 130, the sash-mount portion 116, and the frame-mount portion 126, ensures that when the WOCD 100 is in the locked position/state, the maximum gap between the window sash and the window frame is limited to the maximum locked distance, such as 4 inches. The window sash can be opened further by manually shifting the pin 112 from the locked end of the slot 122 to the first end, and then out of the slot 122 through the notch 130, thereby transitioning to an unlocked position/state. When the WOCD 100 is unlocked, the window can be opened to any arbitrary position.

The operation of moving the pin 112, whether moving it from the locked end to the first end or in the opposite direction, is designed to be feasible with a single-handed effort by the user.

Transitioning the WOCD 100 from the locked to unlocked positions is simple enough to be done by an adult, but complex enough to be challenging to a child. For example, when the WOCD 100 is in the locked position and at maximum extension so that the window is opened to the maximum locked distance (e.g., 4 inches) and the pin 112 is at the end of the slot 122 farthest from the notch 130, transitioning the WOCD 100 to the unlocked position involves pivoting the sash and frame arms 111, 121 to be slightly closer together to allow the pin 112 to then be pushed along the slot 122 by the user. Once the pin 112 is adjacent the notch 130, the user can further pivot one or both of the arms 111, 121 to move the pin 112 out of the slot 122, thereby unlocking the WOCD 100. A user unlocking the WOCD 100 accordingly first slightly pivots the arms 111, 121 when the WOCD 100 is opened as widely as possible when in the locked position to subsequently permit the pin 112 to move from the end of the slot 122 opposite the notch 130 to the end of the slot 122 with the notch 130, following which the pin 112 can exit the slot through the notch 130. When the WOCD 100 is attached to a window, unlocking the WOCD 100 when the window is opened to the maximum locked distance may accordingly involve first slightly closing the window to permit the pin 112 to slide along the slot 122 towards and then out through the notch 130, following which the window can be opened beyond the maximum locked distance. The WOCD 100 can be unlocked in this manner using one hand, permitting the user's other hand to concurrently push/pull or crank the window open/closed, for example.

In one embodiment, at least one spring (not shown) may be provided that connects either or both of the sash and frame arms 111, 121 to their respective sash- or frame-mount portions 116, 126. This spring is configured to exert a biasing force on the end of either the sash arm 111 or the frame arm 121, opposite to the end where the corresponding bolt 131, 132 is located, away from the sash- or frame-mount portions 116, 126. The presence of the spring ensures that, when the WOCD 100 is in the unlocked position, the arm(s) in question is/are held at a particular angle relative to its corresponding mount portion 116 or 126. This angle is defined by the positioning of the stop mechanism (the sash stop 113 or the frame stop 123) as described above. Such a configuration may be advantageous during the closing process of the WOCD 100. By biasing the arm(s) to this angle, the spring allows the pin 112 to first make contact with an edge of the frame arm 121 or the slot edge 125 by default and without the user having to manually reposition the arm(s) biased by the spring(s). Following this initial contact, the pin 112 can be guided to slide along the slot edge 125 towards the notch 130, eventually entering the first end of the slot 122. This occurs before the sash arm 111 and the frame arm 121 are completely nested within the sash-mount portion 116 and the frame-mount portion 126, respectively. Moreover, the arrangement of the slot edge 125, in conjunction with the spring, further facilitates the automatic alignment of the pin 112 into the slot 122 as the window sash closes relative to the window frame. It is worth noting that alternative biasing mechanisms may be employed in place of the spring.

While the embodiment described above with reference to FIGS. 1-4 illustrates an arrangement in which the pin 112 is located on the sash arm 111, and the slot 122 along with the notch 130 are located on the frame arm 121, it should be noted that these positions are interchangeable. Specifically, the pin could alternatively be situated on the frame side, with the slot and the notch being on the sash side. The present disclosure is not intended to limit the scope to the specific configurations illustrated; rather, it is designed to accommodate various modifications and equivalents. This flexibility in the design allows for adaptability and customization to different window construction styles and operational preferences, thereby broadening the applicability and utility of the disclosure.

This embodiment of the WOCD 100 can be used on various types of windows, such as casement windows, awning windows, hopper windows, and tilt- and turn windows. Its configuration ensures compatibility with both residential and commercial window systems, providing an effective solution for enhancing window safety and control in a variety of architectural contexts.

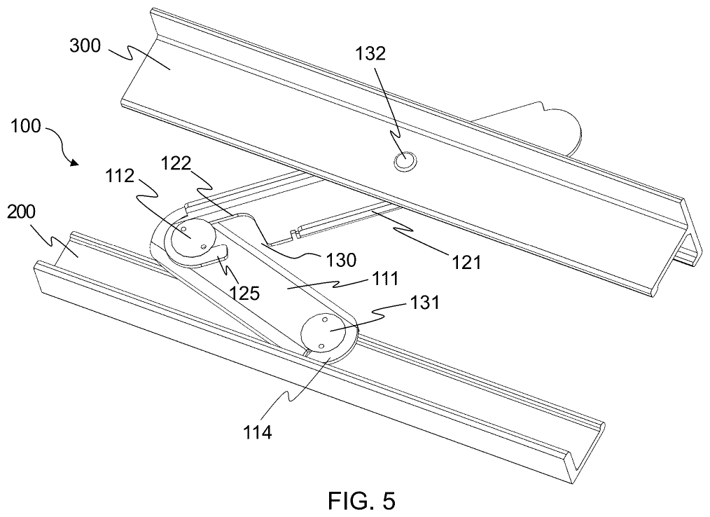

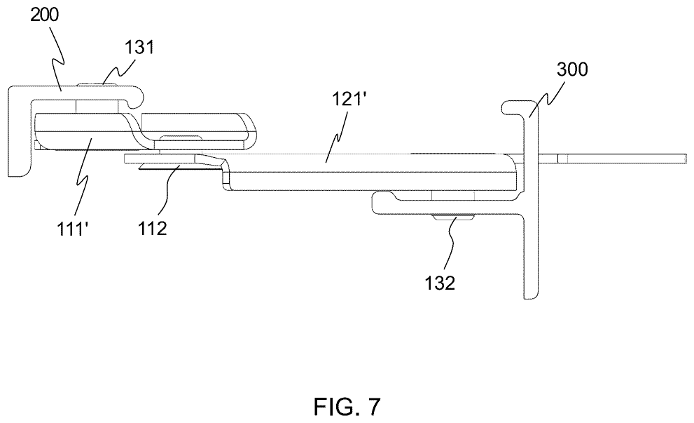

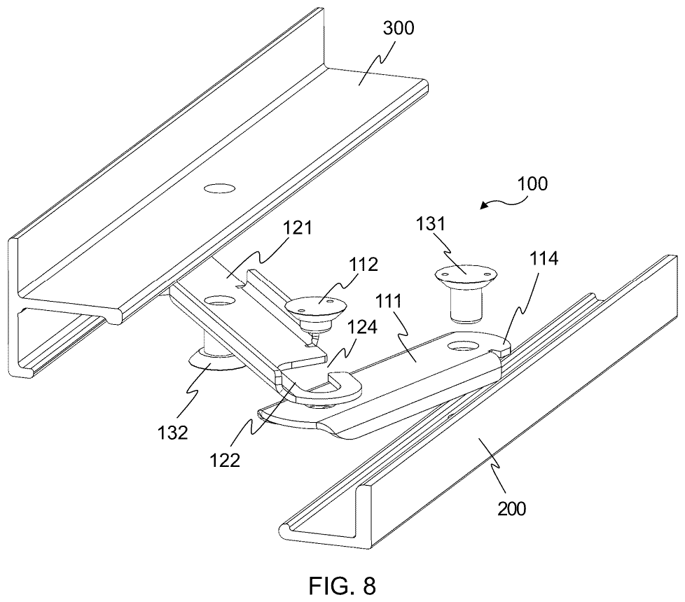

FIGS. 5-8 collectively illustrate a second embodiment of the WOCD 100. These figures are referenced in the detailed description of this embodiment to provide a comprehensive visual guide to its structure and functionality. The second embodiment shares numerous elements with the first embodiment, such as the sash arm 111, the frame arm 121, the pin 112, the slot 122, the notch 130, the sash-mount portion 116, the sash baffle 118, the frame-mount portion 126, the frame baffle 118, the first sash bolt 131, and the first frame bolt 132, while also introducing several modifications. The following description will focus specifically on these modifications, providing a clear distinction from the features of the first embodiment.

In this embodiment, the frame arm 121 may have a greater length compared to the sash arm 111. Specifically, the frame arm 121 is pivotably coupled to the window frame 300 at a location intermediate the ends of the frame arm 121. In other words, the first frame bolt 132 is positioned between the two ends of the frame arm 121.

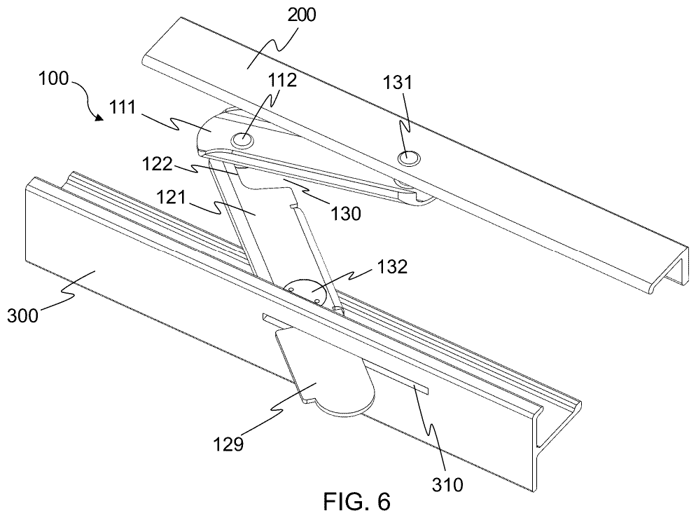

Furthermore, the frame-mount portion 126 is equipped with a frame slot 310 on the frame baffle 128. When the window is opened, a segment 129 of the frame arm 121 can extend out of the frame baffle 128 through the frame slot 310, as depicted in FIG. 6. The segment 129 is accessible to the user and can be maneuvered by the user to adjust the frame arm 121 to facilitate the disengagement of the pin 112 and the slot 122.

While the embodiment described above with reference to FIGS. 5-8 illustrates an arrangement in which the pin 112 is located on the sash arm 111, and the slot 122 along with the notch 130 are located on the frame arm 121, it should be noted that these positions are interchangeable. Specifically, this means that the pin could alternatively be situated on the frame side, with the slot and the notch being on the sash side. Although not shown in FIGS. 5-8, the frame baffle 118 can be secured to the window frame by fasteners such as screws without impeding the pivoting of the segment 129 of the frame arm 121. The present disclosure is not intended to limit the scope to the specific configurations illustrated; rather, it is designed to accommodate various modifications and equivalents. This flexibility in the design allows for adaptability and customization to different window construction styles and operational preferences, thereby broadening the applicability and utility of the disclosure.

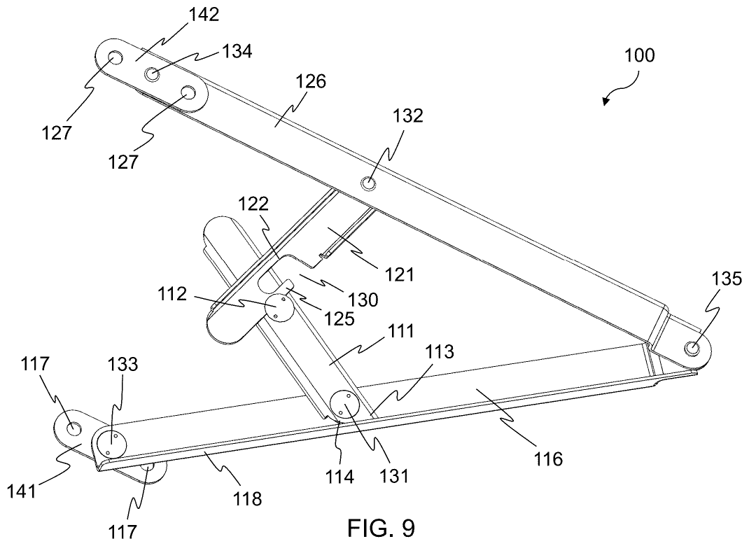

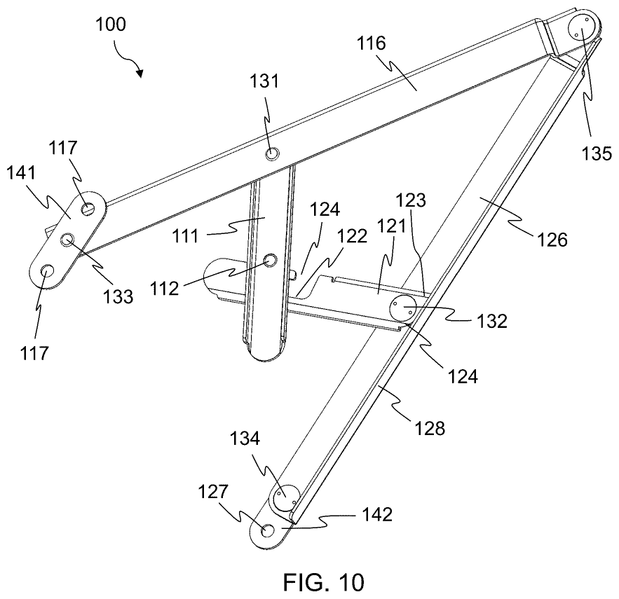

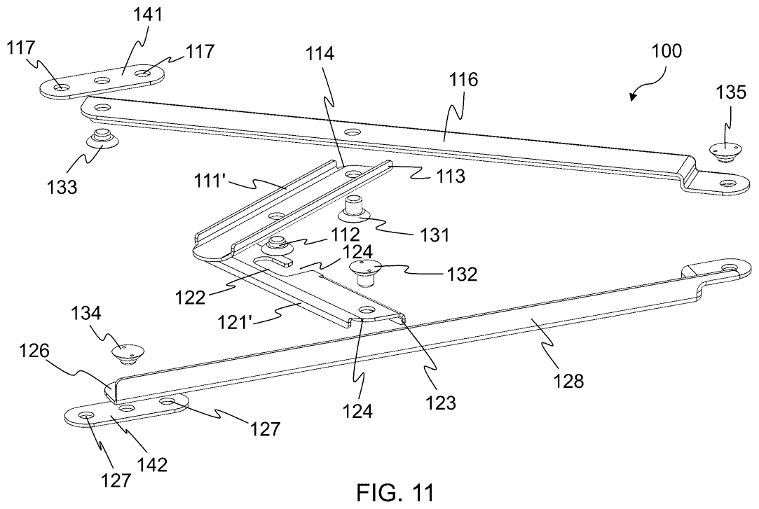

FIGS. 9-11 collectively illustrate a third embodiment of the WOCD 100. These figures are referenced in the detailed description of this embodiment to provide a comprehensive visual guide to its structure and functionality. The third embodiment shares numerous elements with the first embodiment, such as the sash arm 111, the frame arm 121, the pin 112, the slot 122, the notch 130, the first sash bolt 131, and the first frame bolt 132, while also having several modifications. The following description will focus specifically on these modifications, providing a clear distinction from the features of the first embodiment.

In this embodiment, the sash-mount portion 116 and the frame-mount portion 126 are pivotably interconnected via another bolt 135 at one end. At the other end, they can be pivotably attached to the window sash and window frame, respectively, at designated attachment points on the sash-mount portion 116 and the frame-mount portion 126. The incorporation of the bolt 135 facilitates the pivoting movement between the sash-mount portion 116 and the frame-mount portion 126. Consequently, the distance between the attachment points on both the sash-mount portion 116 and the frame-mount portion 126 is reduced when the sash arm 111 and the frame arm 121 are in the locked position, as compared to their distance in the unlocked position.

In addition, this embodiment includes a sash mounting bracket 141 for rigid attachment to the window sash at the attachment point of the sash-mount portion 116. Similarly, a frame mounting bracket 142 is provided for rigid attachment to the window frame at the attachment point of the frame-mount portion 126. The sash mounting bracket 141 is provided with multiple sash mounting holes 117 for rigid attachment to the window sash. Similarly, the frame mounting bracket 142 is provided with multiple frame mounting holes 127 for rigid attachment to the window frame. The assembly also includes a second sash bolt 133 that allows the sash mounting bracket 141 to pivot relative to the sash-mount portion 116, and a second frame bolt 134 that allows similar pivoting movement of the frame mounting bracket 142 relative to the frame-mount portion 126.

In this embodiment, connecting the sash-mount and frame-mount portions 116, 126 using the bolt 135 prevents the window to which the WOCD 100 is attached from opening beyond a maximum unlocked distance determined by the lengths of the sash-mount and frame-mount portions 116, 126. In the depicted embodiment, this maximum unlocked distance is the sum of the lengths of the sash-mount and frame-mount portions 116, 126. In alternative embodiments (not depicted) this maximum distance may be shorter, such as if the sash-mount and frame-mount portions 116, 126 are joined together elsewhere than at their ends. Consequently, a window whose opening is controlled using the WOCD 100 of FIGS. 9-11 is prevented from opening beyond the maximum locked distance (e.g., 4 inches) when the WOCD 100 is in the locked position, and even when in the unlocked position is prevented from opening beyond the maximum unlocked distance determined by the lengths of the sash-mount and frame-mount portions 116, 126.

This embodiment of the WOCD 100 can be used on various types of windows, such as casement windows, awning windows, hopper windows, and tilt- and turn windows. The device retains the same pin and notch mechanism as in other embodiments.

While the embodiment described above with reference to FIGS. 9-11 illustrates an arrangement in which the pin 112 is located on the sash arm 111, and the slot 122 along with the notch 130 are located on the frame arm 121, it should be noted that these positions are interchangeable. Specifically, this means that the pin could alternatively be situated on the frame side, with the slot and the notch being on the sash side. The present disclosure is not intended to limit the scope to the specific configurations illustrated; rather, it is designed to accommodate various modifications and equivalents. This flexibility in the design allows for adaptability and customization to different window construction styles and operational preferences, thereby broadening the applicability and utility of the disclosure.

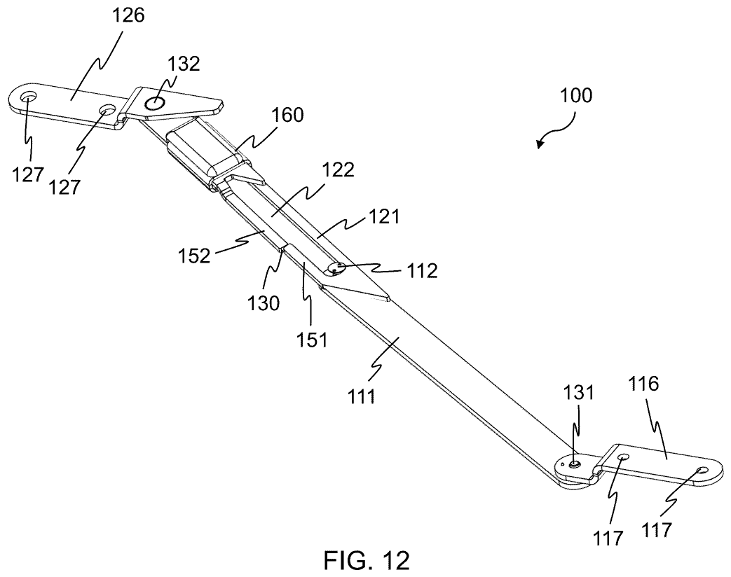

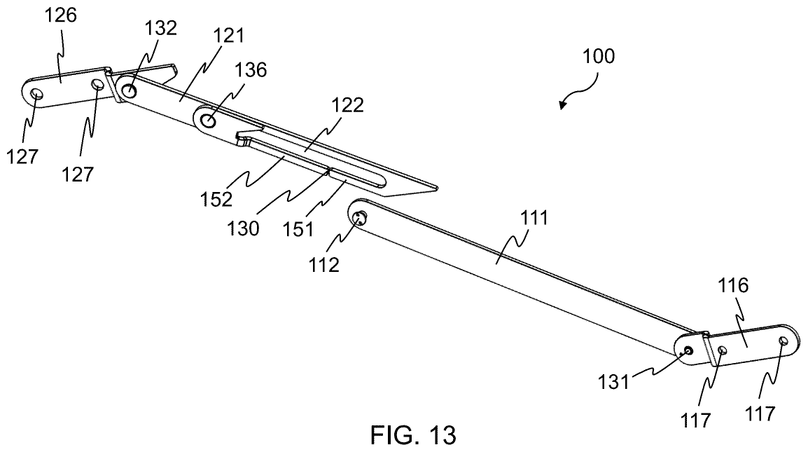

FIGS. 12-14 collectively illustrate a fourth embodiment of the WOCD 100. These figures are referenced in the detailed description of this embodiment to provide a comprehensive visual guide to its structure and functionality. The fourth embodiment shares numerous elements with the first embodiment, such as the sash arm 111, the frame arm 121, the pin 112, the slot 122, the notch 130, the sash-mount portion 116, the frame-mount portion 126, the sash mounting holes 117, the frame mounting holes 127, the first sash bolt 131, and the first frame bolt 132, while also introducing several modifications. The following description will focus specifically on these modifications, providing a clear distinction from the features of the first embodiment.

In this embodiment, the notch 130 is not positioned at either end of the slot 122. Rather, the frame arm 121 includes two fingers 151, 152, which are separated by the notch 130 and may be located on one side of the frame arm 121. The notch 130, located between the first end and the locked end, is sized to prevent the pin 112 from exiting the slot 122 through the notch 130 while the pin is sliding along the finger 151 with the notch 130. One or both of the fingers 151, 152 may be designed to be flexible so that they can be flexed when a force is applied by the user, so as to enlarge the notch 130. Alternatively, one or both of the fingers 151, 152 may be pivotably mounted relative to the frame arm 121 to allow the enlargement of the notch 130 when a user-applied force pivots the finger(s). When the notch 130 is enlarged beyond the size of the pin 112, the pin 112 can be released from the frame arm 121 by user manipulation. Generally, this release operation requires the user to use both hands, which enhances safety.

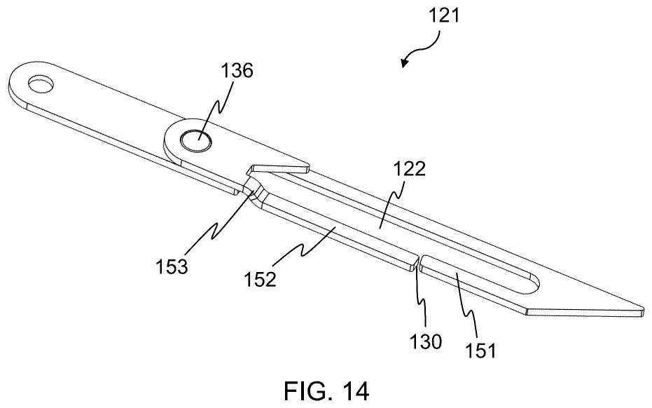

As illustrated in FIG. 14, the frame arm 121 may be composed of two parts. The first part comprises one of the fingers 151, 152 while the second part comprises the other of the fingers 151, 152. The two parts may be secured together using an arm fastener 136. The fingers 151, 152 may be connected to opposing ends of the slot 122 and extend towards each other such that the notch 130 is the vicinity between the tips of the fingers 151, 152. In the depicted embodiment, the fingers 151, 152 are arranged to be misaligned, enabling the user to ascertain the position of the notch 130 tactilely, without the need for visual inspection. Additionally or alternatively, a bent portion 153 may be positioned or formed on one part of the frame arm 121 to facilitate the misalignment of the two fingers 151, 152. This misalignment may create a relatively large notch when no force is applied on the frame arm 121, reducing the amount of flexion required by the fingers 151, 152 to allow the pin 112 to pass through the notch 130. At least one of the fingers 151, 152 is designed to be flexible, thus enabling easy flexion by the user. This flexibility may be achieved by tailoring the dimensions of the finger to permit elastic deformation, while maintaining a relatively rigid form to permit the sliding movement of the pin 112 within the slot 122.

As illustrated in FIG. 12, a sleeve 160 may be slidably mounted on the frame arm 121. The sleeve 160 is adjustable between a protected position, in which the sleeve 160 covers the notch 130, and an unprotected position, in which the notch 130 is exposed. The incorporation of the sleeve 160 enhances safety, as it requires the user to manually slide the sleeve 160 aside prior to flexing the fingers 151, 152 to detach the pin 112 from the frame arm 121.

While the embodiment described above with reference to FIGS. 12-14 illustrates an arrangement in which the pin 112 is located on the sash arm 111, and the slot 122 along with the notch 130 are located on the frame arm 121, it should be noted that these positions are interchangeable. Specifically, this means that the pin 112 could alternatively be situated on the frame arm 121, with the slot 122 and the notch 130 being on the sash arm 111. The present disclosure is not intended to limit the scope to the specific configurations illustrated; rather, it is designed to accommodate various modifications and equivalents. This flexibility in the design allows for adaptability and customization to different window construction styles and operational preferences, thereby broadening the applicability and utility of the disclosure.

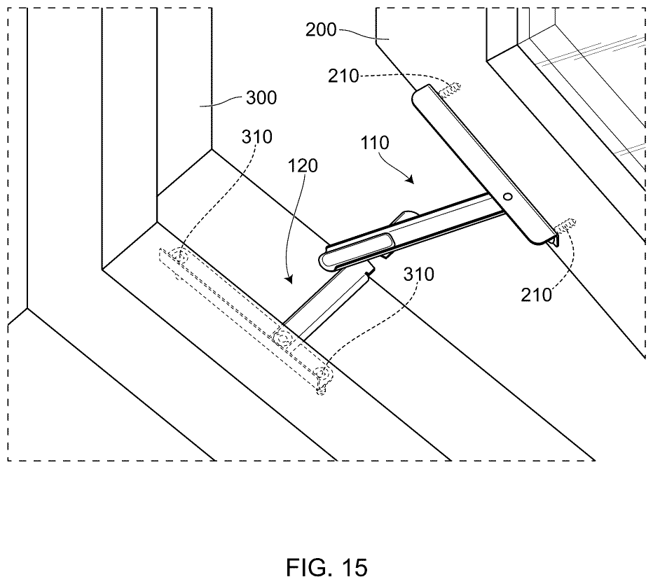

FIG. 15 depicts an embodiment of a window assembly incorporating the WOCD 100 from the embodiment associated with FIGS. 1-4. This assembly comprises the WOCD 100, a window sash 200, and a window frame 300, designed to enable user-operated opening and closing. The sash portion 110 of the WOCD 100 is attached horizontally to the window sash 200 using sash fasteners 210, while the frame portion 120 of the WOCD 100 is attached vertically to the window frame 300 using frame fasteners 310. In the state illustrated, the WOCD 100 is locked, preventing further separation of the window sash 200 and the window frame 300 beyond the maximum locked distance (e.g., 4 inches), constrained by the engagement of the sash arm 111 with the frame arm 121, the positioning of the pin at the slot's locked end, and the sash and frame stops 113, 123 as described above. To further increase the gap between the window sash 200 and the window frame 300, the user can exert force onto the sash arm 111 with one hand to dislodge the pin 112 from the slot 122 while adjusting the opening of the window sash 200 in relation to the window frame 300 with the other hand, for example, by cranking a window crank (not shown). Similarly, when closing the window, the user can simply crank the window sash 200 closed, allowing the sash portion 110 to automatically re-engage with the frame portion 120 through the interaction between the pin 112 and the slot edge 125 and/or the spring mechanism, as previously described.

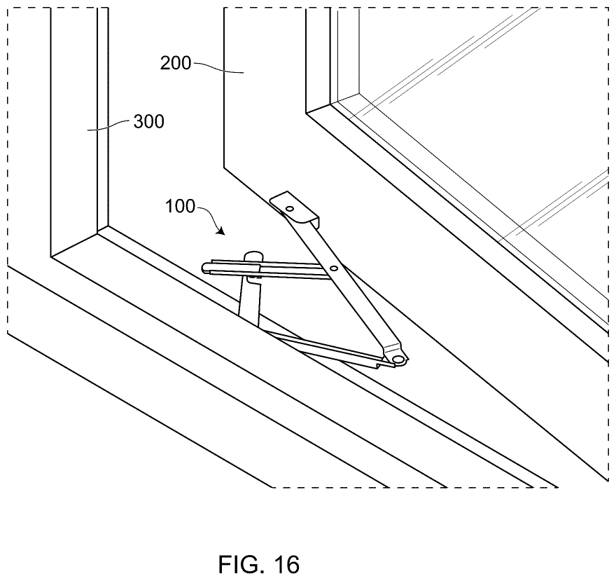

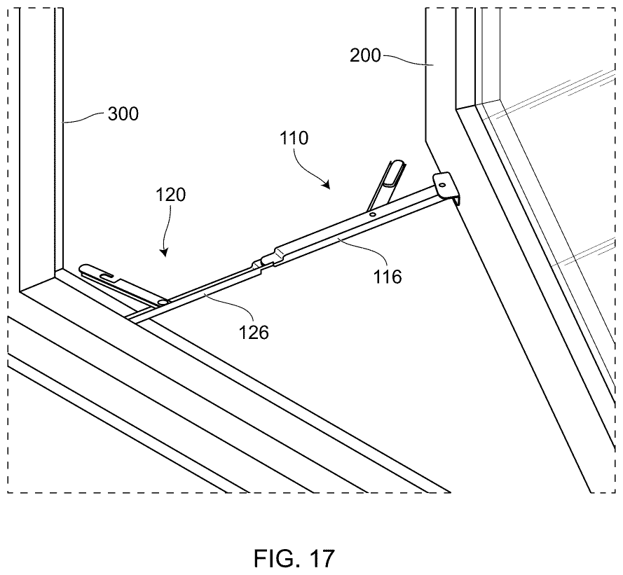

FIGS. 16 and 17 depict an embodiment of a window assembly incorporating the WOCD 100 from the embodiment depicted in FIGS. 9-11. This assembly comprises the WOCD 100, a window sash 200, and a window frame 300, designed to enable user-operated opening and closing. As illustrated in FIG. 16, the WOCD 100 is opened as wide as possible when in the locked position, preventing further separation of the window sash 200 and the window frame 300 beyond the maximum locked distance (e.g., 4 inches). To further increase the gap between the window sash 200 and the window frame 300, the user can exert force onto the sash arm 111 with one hand to dislodge the pin 112 from the slot 122 while adjusting the opening of the window sash 200 in relation to the window frame 300 with the other hand, for example, by cranking. Thereafter, the window sash 200 can be separated from the window frame 300 until the sash-mount portion 116 is aligned with the frame-mount portion 126, thereby opening the WOCD 100 beyond the maximum locked distance and as widely as possible to the maximum unlocked distance as determined by the length of the sash-mount and frame-mount portions. When closing the window, the user can simply bring the window sash 200 closer, allowing the sash portion 110 to automatically re-engage with the frame portion 120 through the interaction between the pin 112 and the slot edge 125 and/or the spring mechanism, as previously described.

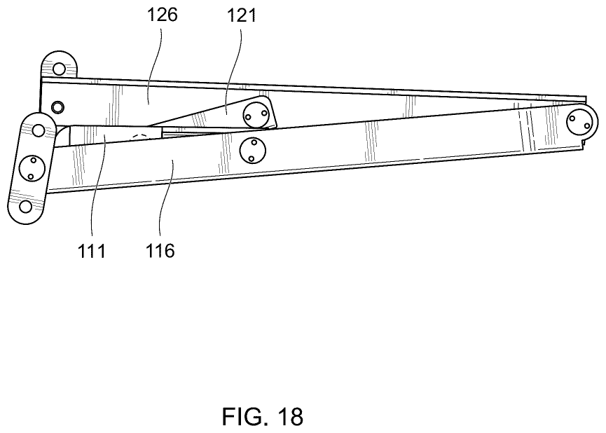

FIGS. 18-22 are a sequence of figures showing the embodiment of the WOCD 100 shown in FIGS. 9-11 being opened and, while being opened, transitioning from the locked to the unlocked positions.

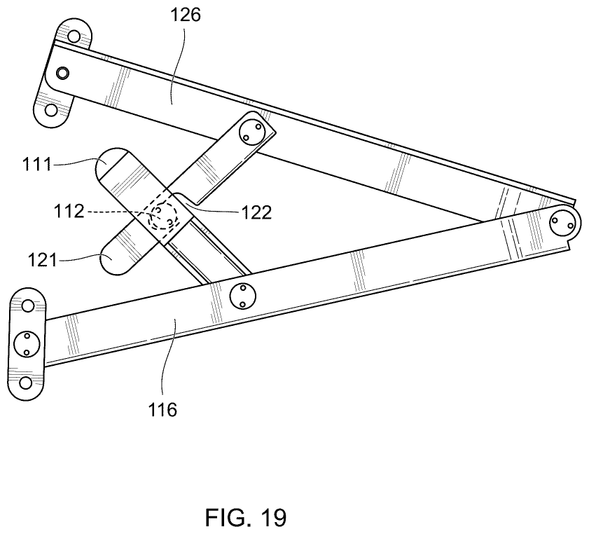

Initially, as shown in FIG. 18, the sash-mount portion 116 and the frame-mount portion 126 are slightly separated from each other from a fully closed position, exposing portions of the sash arm 111 and the frame arm 121. As the user continues to move the mount portions 116, 126 away from each other by opening the window sash 200, the WOCD 100 opens as far as possible while locked (e.g., to a maximum locked distance of 4 inches); i.e., the sash arm 111 remains engaged with the frame arm 121, with the pin 112 secured at the locked end of the slot 122, as illustrated in FIG. 19. At this maximum locked distance, the pin 112 resists movement from the locked end to the first end because of the orientations of the slot 122 and the sash arm 111.

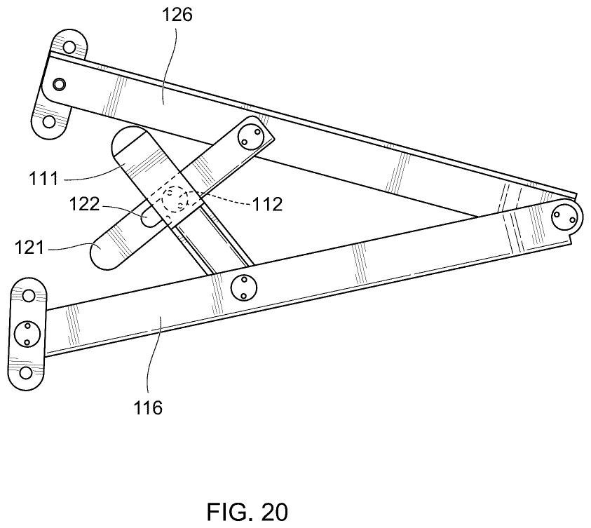

If the user closes the window at this point, the WOCD 100 reverts to the configuration shown in FIG. 18 and subsequently to the fully closed position. Conversely, should the user wish to open the window sash 200 further, the user can remove the pin 112 from the slot 122 by slightly closing the window sash 200 towards the window frame 300 with one hand, such as by cranking a window crank, thereby permitting the other hand to slide the pin 112 towards and then out through the notch 130. FIG. 19 shows the WOCD 100 at the maximum locked distance and FIG. 20 shows the WOCD 100 at a distance slightly smaller than the maximum locked distance, allowing the pin 112 to slide towards the first end of the slot 122. This operation reduces the likelihood of unintentional or accidental operation by children.

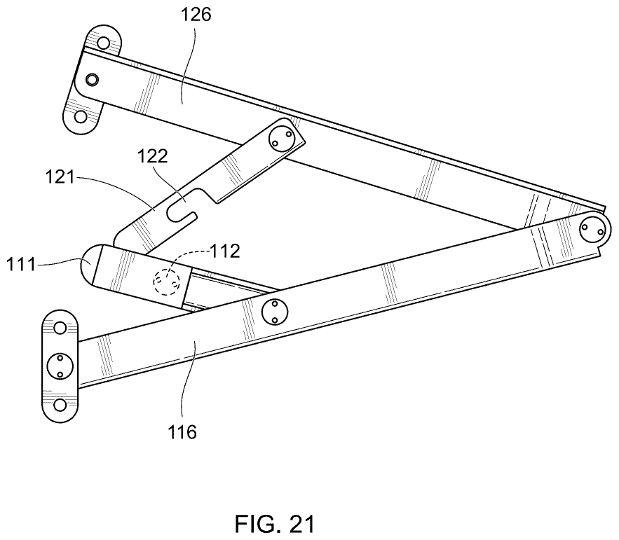

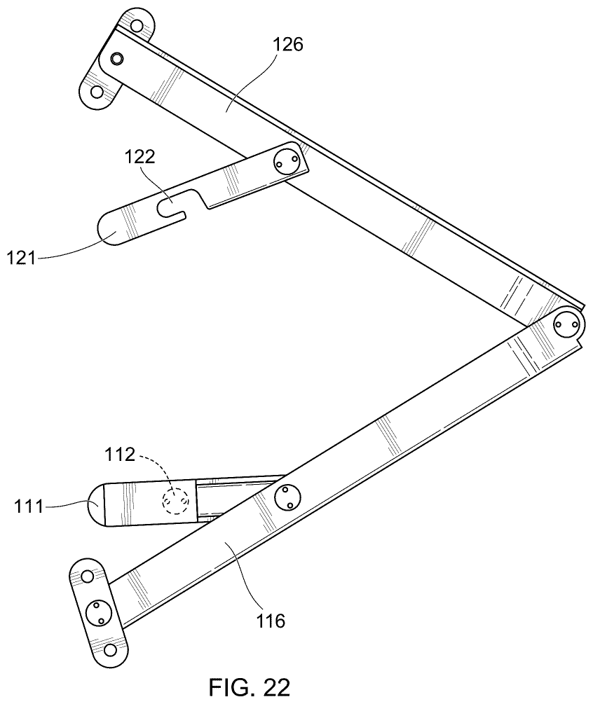

Following this, the pin 112 disengages from the slot 122 via the notch 130, transitioning the WOCD 100 to the unlocked position and permitting further separation between the window sash 200 and the window frame 300, as shown in FIGS. 21 and 22. As the window sash 200 continues to open, eventually the sash-mount portions 116 and frame-mount portions 126 align with each other, which corresponds to the maximum unlocked distance and accordingly the maximum open position of the window.

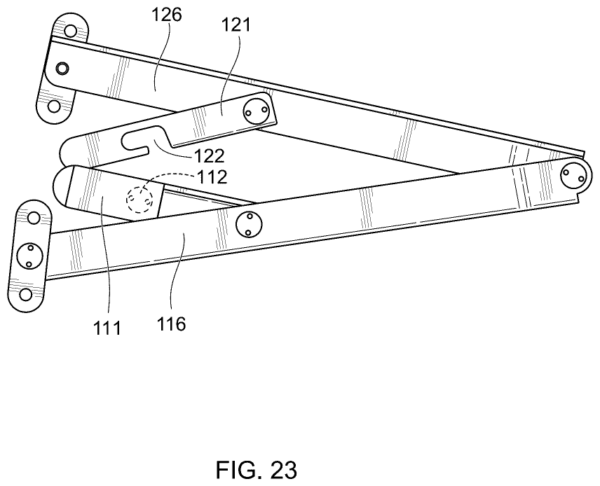

FIGS. 23-25 illustrate sequential operations on the WOCD 100, as featured in the embodiment detailed in FIGS. 9-11. These figures show the transition of the WOCD 100 from an unlocked position to a locked and closed position.

When the user begins to close the window, the sash-mount portion 116 and the frame-mount portion 126 are moved towards each other until the pin 112 makes contact with the opposing arm. In scenarios where a spring mechanism is employed to bias at least one of the arms away from the respective mount portion, this arm can be biased so that the notch 130 is better positioned to receive the pin 112, as shown in FIG. 23.

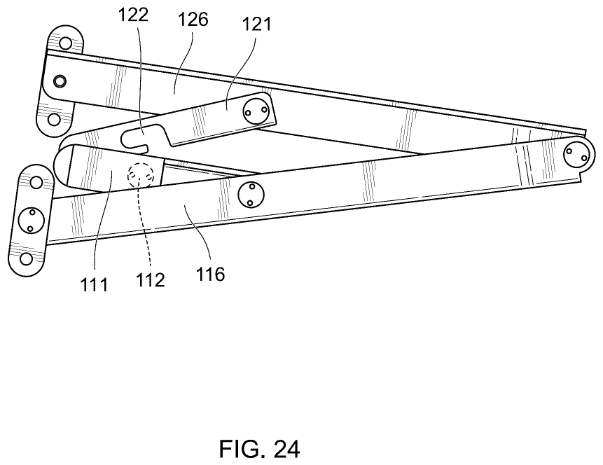

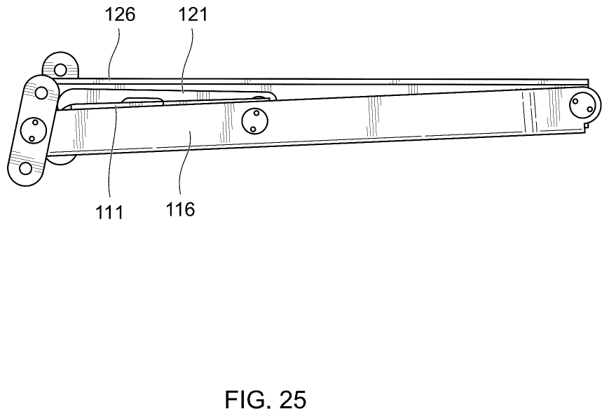

As the window is further closed by the user, the pin slides along the slot edge 125, as depicted in FIG. 24, until it passes through the notch 130 and into the first end of the slot 122, as shown in FIG. 25. Upon the pin's 112 entry into the slot 122, the WOCD 100 reverts to its locked position, returning to the configuration presented in FIG. 18. In the depicted embodiments, when in the locked position the sash and frame arms 111, 121 and sash-mount and frame-mount portions 116, 126 nest together, resulting in the arms 111, 121 and mount portions 116, 126 in the depicted embodiments substantially overlapping with and being coplanar with each other.

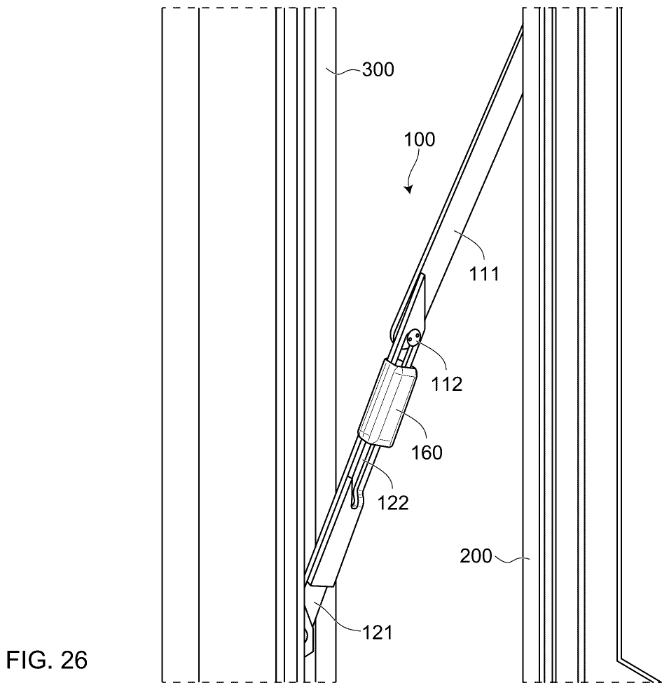

FIGS. 26-28 are a sequence of figures showing the embodiment of the WOCD 100 shown in FIGS. 12-14, transitioning from the locked to the unlocked positions.

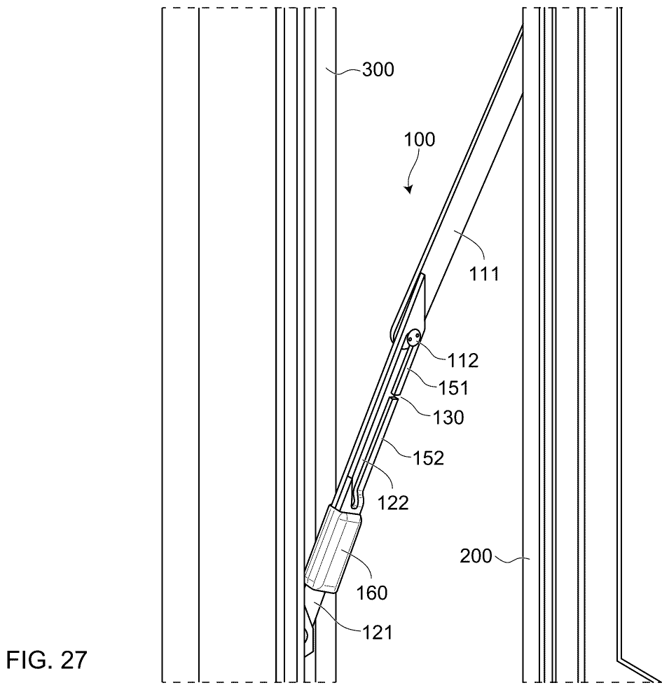

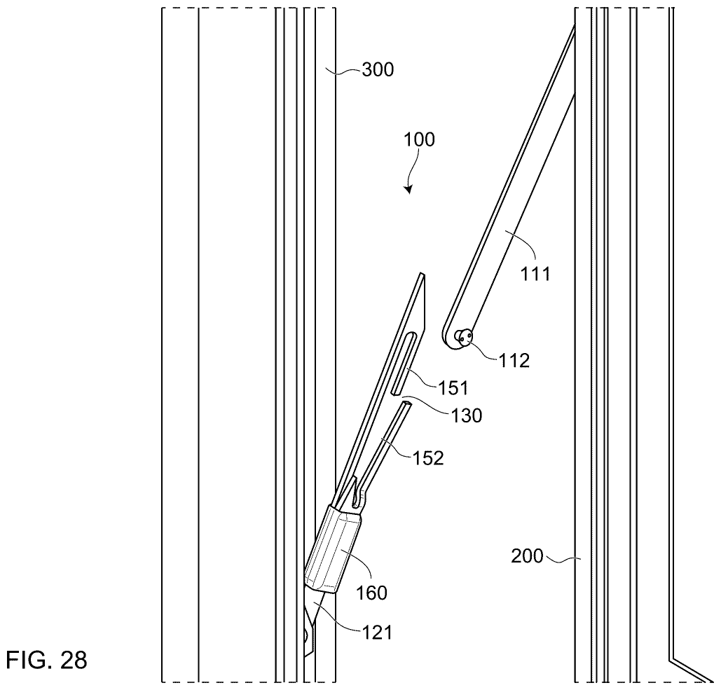

Initially, as shown in FIG. 26, the WOCD 100 is affixed to both the window sash 200 and the window frame 300, with the pin 112 secured at the locked end of the slot 122, placing the WOCD 100 in a locked position. The user can exert a force on the sleeve 160 to adjust its position, moving the sleeve 160 from the protected to the unprotected position, thereby exposing the notch 130, as shown in FIG. 27. Subsequently, the user may flex or bend one of the fingers 151, 152 to enlarge the notch 130 using one hand, while simultaneously pulling the sash arm 111 with the other hand, allowing the pin 112 to slide within the slot 122 and exit through the enlarged notch 130, as illustrated in FIG. 28. This action detaches the sash arm 111 from the frame arm 121, enabling further opening of the window.

When the user wishes to re-engage the sash arm 111 with the frame arm 121, they may flex or bend one of the fingers to enlarge the notch 130 with one hand and use the other hand to pull the sash arm 111, guiding the pin 112 to pass through the enlarged notch 130 and re-enter the slot 122. Consequently, the pin 112 can return to the locked position and be slidable between the first end and the locked end. The user can then slide the sleeve 160 back to the protected position, covering the notch 130. When the pin 112 is secured in the slot 122 and the sleeve 160 is in the protected position, the maximum distance between the window sash 200 and the window frame 300 is predetermined, such as 4 inches. In this way, opening or closing of the window is allowed within a small range by the adjustable length of the window opening control device 100 because the pin 112 is securely slidable in the slot 122.

It should be understood that various modifications, alterations, and adaptations may be made to the specific elements and configurations disclosed, including but not limited to dimensions, materials, positions, and operational mechanisms, without departing from the essence and scope of the disclosure.

The terminology used herein is only for the purpose of describing particular embodiments and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

It is contemplated that any part of any aspect or embodiment discussed in this specification can be implemented or combined with any part of any other aspect or embodiment discussed in this specification, so long as such those parts are not mutually exclusive with each other.

While every effort has been made to provide a detailed and accurate description of the disclosure herein, it should be noted that the scope of the disclosure is not limited to the exact configurations and embodiments described. The description provided is intended to illustrate the principles of the disclosure and not to limit the disclosure to the specific embodiments illustrated. It is intended that the scope of the disclosure be defined by the appended claims, their equivalents, and their potential applications in other fields.

1. A window opening control device comprising:
a frame portion comprising:
a frame-mount portion for coupling to a window frame; and
a frame arm pivotably coupled to the frame-mount portion, wherein the frame arm comprises one of a pin or a slot, wherein the pin is shaped to fit within the slot; and
a sash portion comprising:
a sash-mount portion for coupling to a window sash; and
a sash arm pivotably coupled to the sash-mount portion, wherein the sash arm comprises the other of the pin or the slot,
wherein the frame and sash arms are movable between an unlocked position in which the pin is outside the slot, and a locked position in which the pin is secured in the slot, wherein the arm that comprises the slot further comprises a notch for permitting the pin to slide therethrough and into the slot, and wherein the pin is slidable to a locked end of the slot when the frame and sash arms are in the locked position.

2. The window opening control device of claim 1, wherein the arm comprising the slot comprises two fingers separated by the notch, and wherein at least one of the fingers is flexible or pivotable relative to the arm to permit enlargement of the notch such that the pin is able to pass through the notch.

3. The window opening control device of claim 2, wherein the two fingers are connected at opposing ends of the slot and extend such that ends of the two fingers are misaligned relative to each other.

4. The window opening control device of claim 1, further comprising a sleeve slidably mounted on the arm that comprises the slot, wherein the sleeve is adjustable between a protected position, in which the sleeve covers the notch, and an unprotected position, in which the notch is exposed.

5. The window opening control device of claim 2, wherein the notch is sized to prevent the pin from exiting the slot through the notch when the pin is in the slot and the at least one of the fingers is unflexed or unpivoted.

6. The window opening control device of claim 1, wherein the pin and the slot are positioned such that the frame and sash arms automatically return to the locked position when the window frame is closed against the window sash.

7. The window opening control device of claim 1, wherein an end of the frame arm is pivotably coupled to the frame-mount portion, wherein one half of the end of the frame arm comprises a curved edge to allow the frame arm to pivot about the frame-mount portion with the curved edge rotating adjacent a frame baffle of the frame-mount portion, and wherein an opposing half of the end of the frame arm is shaped to abut against the frame baffle of the frame-mount portion to limit pivoting of the frame arm.

8. The window opening control device of claim 1, wherein an end of the sash arm is pivotably coupled to the sash-mount portion, wherein one half of the end of the sash arm comprises a curved edge to allow the sash arm to pivot about the sash-mount portion along the curved edge rotating adjacent a sash baffle of the sash-mount portion, and wherein an opposing half of the end of the sash arm is shaped to abut against the sash baffle of the sash-mount portion to limit pivoting of the sash arm.

9. The window opening control device of claim 1, further comprising at least one spring connecting at least one of the arms to at least one of the frame-mount and sash-mount portions, respectively, wherein the at least one spring biases an end of the at least one of the arms away from the at least one of the frame-mount and sash-mount portions, respectively.

10. The window opening control device of claim 1, wherein the frame arm is pivotably coupled to the frame-mount portion between ends of the frame arm, and wherein the frame-mount portion comprises a frame slot through which a segment of the frame arm is extendable.

11. The window opening control device of claim 1, wherein the frame-mount and sash-mount portions are pivotably coupled to each other and pivotably couplable to the window frame and the window sash at attachment points on the frame-mount and sash-mount portions, respectively, and
wherein the attachment points on the frame-mount and sash-mount portions are closer to each other when the frame and sash arms are in the locked position than when the frame and sash arms are in the unlocked position.

12. The window opening control device of claim 1, wherein when in the locked position a window to which the window opening control device is attached is prevented from opening beyond approximately 4 inches.

13. A window assembly comprising:
a window frame;
a window sash; and
a window opening control device, comprising:
a frame portion comprising:
a frame-mount portion coupled to the window frame; and
a frame arm pivotably coupled to the frame-mount portion, wherein the frame arm comprises one of a pin or a slot, wherein the pin is shaped to fit within the slot; and
a sash portion comprising:
a sash-mount portion coupled to the window sash; and
a sash arm pivotably coupled to the sash-mount portion, wherein the sash arm comprises the other of the pin or the slot,
wherein the frame and sash arms are movable between an unlocked position in which the pin is outside the slot, and a locked position in which the pin is secured in the slot, wherein the arm that comprises the slot further comprises a notch for permitting the pin to slide therethrough and into the slot, wherein the pin is slidable to a locked end of the slot when the frame and sash arms are in the locked position.

14. The window assembly of claim 13, wherein the arm comprising the slot comprises two fingers separated by the notch, and wherein at least one of the fingers is flexible or pivotable relative to the arm to permit enlargement of the notch such that the pin is able to pass through the notch.

15. The window assembly of claim 14, wherein the two fingers are connected at opposing ends of the slot and extend such that ends of the two fingers are misaligned relative to each other.

16. The window assembly of claim 13, wherein the window opening control device further comprises a sleeve slidably mounted on the arm that comprises the slot, wherein the sleeve is adjustable between a protected position, in which the sleeve covers the notch, and an unprotected position, in which the notch is exposed.

17. The window assembly of claim 14, wherein the notch is sized to prevent the pin from exiting the slot through the notch when the pin is in the slot and the at least one of the fingers is unflexed or unpivoted.

18. A method for operating a window opening control device, the window opening control device comprising a frame portion and a sash portion, the frame portion comprising a frame-mount portion for coupling to a window frame and a frame arm pivotably coupled to the frame-mount portion, the sash portion comprising a sash-mount portion for coupling to a window sash and a sash arm pivotably coupled to the sash-mount portion, wherein the method comprises:
opening the sash-mount portion away from the frame-mount portion when a pin on one of the frame arm or sash arm is secured in a slot on the other of the frame arm or sash arm, until the window opening control device opens to a maximum locked distance and further opening is prevented by virtue of the pin abutting against a locked end of the slot;
closing the sash-mount portion towards the frame-mount portion with one hand so that the window sash is spaced from the window frame by less than the maximum locked distance;
removing the pin from the slot with the other hand; and then further opening the sash-mount portion away from the frame-mount portion.

19. The method of claim 18, further comprising, prior to removing the pin from the slot:
adjusting a sleeve that is slidably mounted on the arm that comprises the slot from a protected position, in which the sleeve covers the notch, to an unprotected position, in which the notch is exposed.

20. The method of claim 18, wherein the arm comprising the slot comprises two fingers separated by the notch, and wherein removing the pin from the slot comprises:
flexing at least one of the fingers to enlarge the notch such that the pin is able to pass through the notch.
